(19) United States
(12) Patent Application Publication
(10) Pub. No.: US 2012/0067831 A1
(43) Pub. Date: Mar. 22, 2012

(54) Apparatus for and method of recovering clean drilling fluid from fluid contaminated with entrained debris

(76) Inventor: John Astleford, Lincoln (GB)

(21) Appl. No.: 13/199,969

(22) Filed: Sep. 14, 2011

(30) Foreign Application Priority Data
Sep. 17, 2010 (GB) 1015578.6

(51) Int. Cl. B01D 33/00; B01D 37/00

(52) U.S. Cl. 210/785; 210/324; 210/806

(57) ABSTRACT

Apparatus for recovering clean drilling fluid from fluid contaminated with entrained debris comprises an input conduit for the contaminated drilling fluid, the conduit being branched whereby a portion of the contaminated fluid is delivered to a preliminary separation stage and the remainder flows to a main separation stage, each said stage comprising a screen for separating debris from the fluid. The preliminary separation stage comprises a vibrating screen and conveyor means for conveying separated debris into the remainder flow to the main separator stage, thereby increasing the proportion of entrained debris in the remaining fluid.

### RELATED APPLICATION

This patent application claims priority to United Kingdom Patent Application No. 1015578.6, filed Sep. 17, 2010, the disclosure of which is incorporated herein by reference in its entirety.

### FIELD OF THE INVENTION

This invention relates to apparatus for and method of recovering clean drilling fluid from fluid contaminated with entrained debris, for example used in the drilling of oil or gas wells.

### BACKGROUND TO THE INVENTION

Typically, the proportion of debris to fluid in used drilling fluids is up to 10%. All prior art vibrating screening devices, commonly referred to in the petroleum industry as “shale shakers”, therefore have to deal with a high ratio of fluid to debris. In most cases, the ideal screen size and/or the ideal flow rate cannot be achieved because the screen conductance decreases with decreasing screen hole size aperture. Thus, to avoid loss of fluid, in most cases the screen aperture is increased, with the resultant reduction in the amount of debris that is removed. This results in increased cost and reduced performance of the fluid.

Previous upgrades all require removal of existing Shale Shakers and replacement of upgrades, the cost of this usually cannot be justified for short term projects (Most Companies that drill for oil and gas contract out drilling rigs for short periods of time). The total cost of upgrading equipment would normally be in the region of 0.5 to 1 million dollars.

Additionally, on many older-designed drilling rigs it is not possible to add additional equipment of the conventional type to cope with the required flow rates necessary to meet the requirements of modern-day drilling techniques. This may be because there is insufficient space to add equipment, or no cost-effective means of disposing of the debris once this has been separated out of the fluid by conventional equipment.

The purpose of this invention is to improve the efficiency of conventional shakers by reducing the amount of fluid with the debris arriving at the shaker.

### SUMMARY OF THE INVENTION

Accordingly, the invention provides apparatus for recovering clean drilling fluid from fluid contaminated with entrained debris, comprising an input conduit for the contaminated drilling fluid, the conduit being branched whereby a portion of the contaminated fluid is delivered to a preliminary separation stage and the remainder flows to a main separation stage, each said stage comprising a screen for separating debris from the fluid, the preliminary separation stage comprising a vibrating screen and conveyor means for conveying separated debris into the remainder flow to the main separator stage, thereby increasing the proportion of entrained debris in the remaining fluid.

Preferably, the preliminary filtration stage comprises drive means for causing oscillation of the screen, and wherein the screen is arranged such that fluid entering the filtration stage passes horizontally or in an upward direction through the screen and debris retained by the screen can fall downwardly from the screen on to the conveyor means. The conveyor means is suitably an auger.

The screen in the preliminary separation stage preferably comprises a plurality of faces, each adjacent pair of faces being joined together with an acute angle therebetween and each face making an acute angle with the vertical. The lowermost joins between adjacent faces are preferably spaced apart from each other by 0.02 to 0.1 m. The drive means may be arranged to oscillate the screen in a horizontal direction, perpendicular to the face of the screen.

The invention also provides a method of recovering clean drilling fluid from fluid contaminated with entrained debris, comprising passing a portion of a fluid flow containing entrained debris through a preliminary separation stage in which a portion of the fluid is separated, and passing the remainder of the fluid flow through a main separation stage to separate further fluid from the debris, wherein the debris separated from fluid in the preliminary separation stage is reintroduced into the remainder of the fluid flow prior to entry into the main separation stage.

Preferably, the method comprises passing fluid entering the preliminary separation stage horizontally or in an upward direction through a screen and allowing debris retained by the screen to fall downwardly from the screen on to conveyor means, and transporting the debris by means of the conveyor means into the remainder of the fluid flow.

Multiple units of the preliminary separation stage can be installed on a flow line depending on the required increase in the proportion of debris to fluid required. In practice the flow line still has to adequately transport the debris down the line so this proportion is limited to about 50% by volume.

### BRIEF DESCRIPTION OF THE DRAWINGS

In the drawings, which illustrate an exemplary embodiment of the apparatus of the invention:

FIG. 1 is a schematic diagram of the apparatus;

FIG. 2 is a diagrammatic side sectional view of the preliminary separation stage of the apparatus; and

FIG. 3 is an end view of the apparatus shown in FIG. 2.

### DETAILED DESCRIPTION OF THE ILLUSTRATED EMBODIMENT

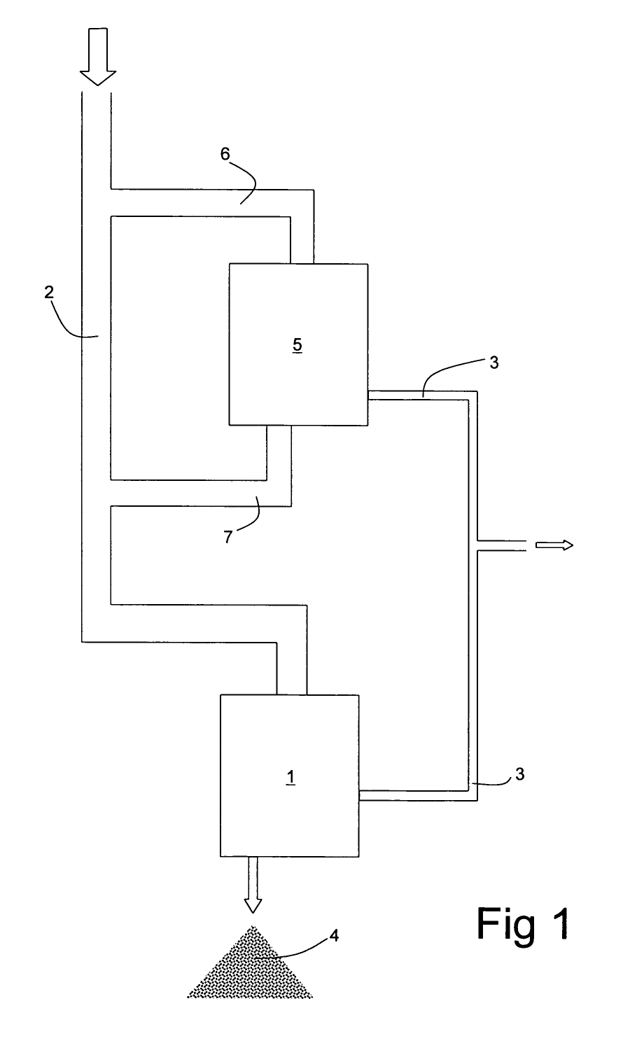

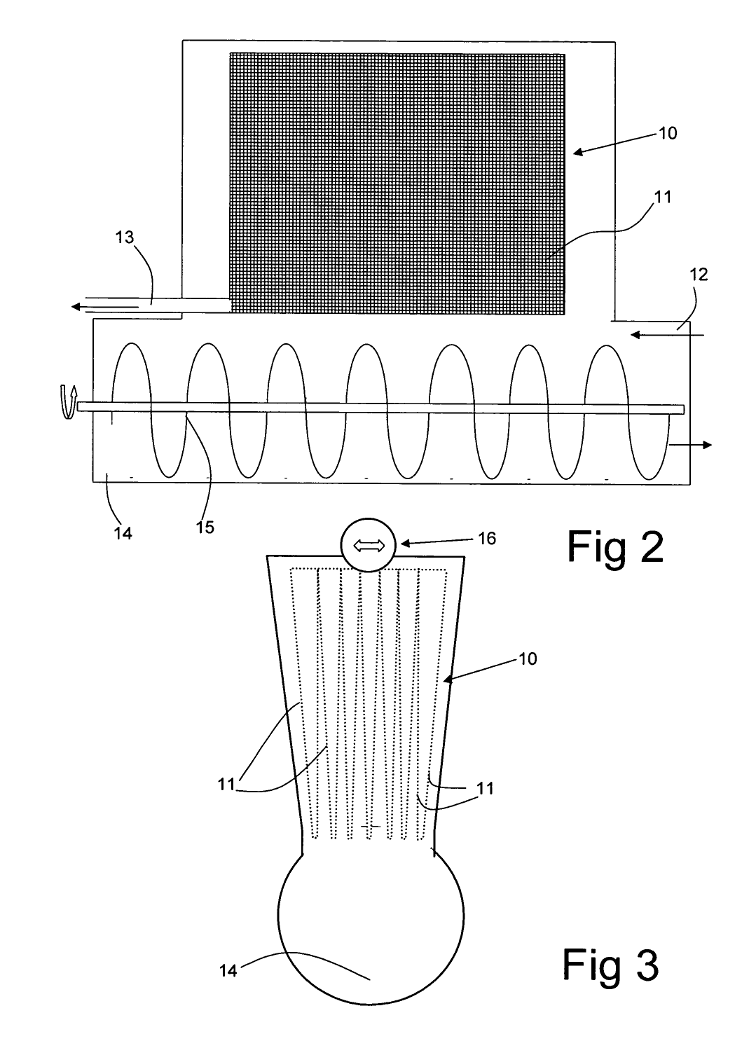

Referring first to FIG. 1, apparatus installed at a wellhead, for example, typically comprises a vibrating screen device 1, in which the drilling fluid and entrained debris from an oil or gas well flows via a supply conduit 2 on to a vibrating screen, the fluid passing through for the screen and flowing into a pipeline 3 for re-use, and the debris passing along the screen for collection at 4 for disposal. In accordance with the present invention, a preliminary separation stage 5 is installed upstream from this main separation stage. A branch conduit 6 takes a part of the flow from the upper side of the supply conduit 2 into the preliminary stage 5, which will be described in more detail hereinafter with reference to FIGS. 2 and 3. The supply conduit will typically be downwardly inclined to assist flow of the contaminated fluid, and there is naturally a tendency for the entrained solids to fall to the lower part of the conduit under the influence of gravity. Taking the branch from the upper side of the conduit reduces the solids content in the fluid flowing into the preliminary stage. The preliminary stage 5 separates clean fluid from the flow supplied to it and passes this to the pipeline 3, while the debris remaining is conveyed via a return conveyor or conduit, indicated schematically at 7, into the supply conduit so that the debris content of the fluid arriving at the main separation stage is increased, thereby reducing losses of fluid in this stage.

While the inlet conduit 6 and the outlet conduit 7 are shown in FIG. 1 as separate from one another, it is feasible to combine both in one pipe, as described hereinafter with reference to FIGS. 2 and 3, so that a single direct connection to the supply conduit can be used, minimising the amount of fabrication and welding that has to be done on a drilling rig.

Referring now to FIGS. 2 and 3, the preliminary separation stage comprises a screen assembly 10 consisting a plurality of screens 11, each making an acute angle with the vertical and with the next adjacent screen, the screens being joined together alternately at the tops and the bottoms so as to provide a continuous screen surface as a series of vees joined at the tops. The spaces between adjacent vees are exposed to the incoming fluid and debris supplied through inlet 12, while the interiors of the vees are connected to a fluid outlet 13. The screen assembly is provided with a driver, illustrated schematically at 16, to oscillate or vibrate the assembly. The driver may be a prior art vibrator used for vibrating screens, but while conventionally the direction of vibration is at around 45 degrees to the face of a near-horizontal screen face, the direction of vibration in the illustrated embodiment is generally perpendicular to the near vertical screen face. Oscillations may be linear of elliptical, and are generally at a frequency in the range of 500 to 1000 oscillations per minute. The amplitude of the oscillations is suitably of the order of 1 to 10 mm.

Debris coming into contact with the screens as the fluid passes generally horizontally or upwardly through them is shaken off the screens to fall downwardly into a collection area 14 containing an auger 15, which can be rotated to compact and push the debris out of the separation stage and along the return conveyor or conduit 7 into the supply conduit to mix with the remainder of the flow of fluid and entrained debris that bypassed the preliminary separation stage 5. Alternatively, it may be desirable to return the solids via a separate conduit (not shown) directly on to the shale shaker if elevations allow.

The screening assembly will preferably be constructed to be totally enclosed so that no debris-laden fluid can find its way into the internal area of the screen. A separate conduit will allow screened fluid to flow from the internal space in the screening assembly out of the device for re-use. Alternatively, the uppermost section of the screening assembly may be left open, provided that it is arranged such that the level of the debris-laden fluid does not allow flow over the top of the screening device to contaminate the screened fluid.

What is claimed is:

1. Apparatus for recovering clean drilling fluid from fluid contaminated with entrained debris, comprising an input conduit for the contaminated drilling fluid, the conduit being branched whereby a portion of the contaminated fluid is delivered to a preliminary separation stage and the remainder flows to a main separation stage, each said stage comprising a screen for separating debris from the fluid, the preliminary separation stage comprising a vibrating screen and conveyor means for conveying separated debris into the remainder flow to the main separator stage, thereby increasing the proportion of entrained debris in the remaining fluid.

2. Apparatus according to claim 1, wherein said preliminary filtration stage comprises drive means for causing oscillation of the screen, and wherein the screen is arranged such that fluid entering the filtration stage passes horizontally or in an upward direction through the screen and debris retained by the screen can fall downwardly from the screen on to the conveyor means.

3. Apparatus according to claim 1, wherein the conveyor means is an auger.

4. Apparatus according to claim 1, wherein the screen in the preliminary separation stage comprises a plurality of faces, each adjacent pair of faces being joined together with an acute angle therebetween and each face making an acute angle with the vertical.

5. Apparatus according to claim 4, wherein the lowermost joins between adjacent faces are spaced apart from each other by 0.02 to 0.1 m.

6. Apparatus according to claim 2, wherein the drive means is arranged to oscillate the screen in a horizontal direction.

7. A method of recovering clean drilling fluid from fluid contaminated with entrained debris, comprising passing a portion of a fluid flow containing entrained debris through a preliminary separation stage in which a portion of the fluid is separated, and passing the remainder of the fluid flow through a main separation stage to separate further fluid from the debris, wherein the debris separated from fluid in the preliminary separation stage is reintroduced into the remainder of the fluid flow prior to entry into the main separation stage.

8. A method according to claim 7, comprising passing fluid entering the preliminary separation stage horizontally or in an upward direction through a screen and allowing debris retained by the screen to fall downwardly from the screen on to conveyor means, and transporting the debris by means of the conveyor means into the remainder of the fluid flow.

9. A method according to claim 8, comprising oscillating the screen to dislodge debris therefrom.
